(19) United States
(12) Patent Application Publication
(10) Pub. No.: US 2026/0213294 A1
(43) Pub. Date: Jul. 23, 2026

(54) METHOD FOR RECOVERING METALS

(71) Applicant: JX METALS CIRCULAR SOLUTIONS CO., LTD., Tokyo (JP)

(72) Inventor: Junichi ARAKAWA, Hitachi-shi (JP)

(73) Assignee: JX METALS CIRCULAR SOLUTIONS CO., LTD., Tokyo (JP)

(21) Appl. No.: 19/142,454

(22) PCT Filed: Feb. 29, 2024
(86) PCT No.: PCT/JP2024/007635

§ 371 Date: Jun. 23, 2025

(30) Foreign Application Priority Data
Mar. 30, 2023 (JP) 2023-056741

(51) Int. Cl. H01M 10/54; C01D 15/02; C01D 15/08; C22B 3/22; C22B 7/00; C22B 26/12; H01M 10/0525

(52) U.S. Cl. CPC H01M 10/54; C01D 15/02; C01D 15/08; C22B 3/22; C22B 7/007; C22B 26/12; H01M 10/0525

(57) ABSTRACT

It is possible to effectively suppress an increase in sodium concentration when lithium is circulated in a liquid in a series of steps. A method for recovering metals from battery powder of lithium ion battery waste includes: an acid leaching step of leaching metals including lithium, sodium and a metal to be separated in the battery powder into an acidic leaching solution to obtain a metal-containing solution containing the metals; and a metal separation step of separating the metal to be separated, from the metal-containing solution, wherein the lithium in the lithium-containing solution obtained after the metal separation step is returned to the acid leaching step and/or the metal separation step to circulate the lithium within a series of steps including the acid leaching step and the metal separation step, and wherein the method further includes, after the metal separation step, a liquid removing step of removing part of the lithium-containing solution containing sodium.

### TECHNICAL FIELD

This specification discloses a method for recovering metals.

### BACKGROUND ART

In recent years, it has been widely studied for recovery of valuable metals such as cobalt and nickel contained in lithium ion battery waste discarded for expired product life, manufacturing defects or other reasons, in terms of effective utilization of resources.

In order to recover valuable metals from lithium ion battery waste, for example, wet processes are subjected to powder of batteries (“battery powder”) that is obtained through dry preprocessing such as roasting of lithium ion battery waste.

Specifically, in the wet processes, metals such as cobalt, nickel, manganese, lithium, aluminum, and iron in the battery powder are leached with an acid to obtain a metal-containing solution containing the metals dissolved therein. Aluminum, iron, manganese, and the like, among respective elements contained the metal-containing solution, are then sequentially or simultaneously removed by neutralization or solvent extraction, as described, for example, in Patent Literature 1. Cobalt and nickel in the metal-containing solution are then separated by solvent extraction and concentrated. The separation of the nickel by extraction results in a lithium-containing solution in which lithium dissolves and remains. The lithium-containing solution thus obtained is subjected to, for example, concentration of lithium ions by repeating solvent extraction, and then subjected to carbonation by adding a carbonate salt or blowing a carbon dioxide gas, thereby recovering the lithium ions in the lithium-containing solution as lithium carbonate.

Regarding such a method for recovering metals, in order to “suppress the use of sodium hydroxide as a pH adjusting agent and efficiently recover metals from lithium ion battery waste”, Patent Literatures 2 and 3 disclose “a method for recovering metals from lithium ion battery waste, the method including a wet process to leach metals containing lithium in the lithium ion battery waste with an acid and remove the metals from a metal-containing solution having the metals dissolved therein, wherein the lithium removed in the wet process is used as a pH adjusting agent used in the wet process. Also, Patent Literatures 2 and 3 disclose that:
“a series of steps including an acid leaching step, a manganese extraction step, a cobalt extraction step, a nickel extraction step, and a hydroxylation step is repeated multiple times, and in the series of steps, at least part of the lithium is circulated in the liquid”.

### CITATION LIST

### Patent Literature

PTL 1: Japanese Patent No. 6801090 B

PTL 2: Japanese Patent No. 7100211 B

PTL 3: Japanese Patent No. 7100217 B

### SUMMARY OF INVENTION

### Technical Problem

By the way, the lithium ion battery waste and battery powder obtained therefrom may contain sodium. The sodium is leached out with an acid together with metals such as lithium in the battery powder and contained in the metal-containing solution, and shows similar behavior to lithium in the wet process.

Therefore, as described in Patent Literatures 2 and 3, when lithium is circulated in a series of steps, not only the lithium concentration but also the sodium concentration in the liquid gradually increases as the battery powder is introduced into the wet process. An increase in the sodium concentration leads to a decrease in the quality of lithium recovered by the method for recovering metals.

This specification provides a method for recovering metals, which can effectively suppress an increase in sodium concentration when lithium is circulated in a liquid in a series of steps.

### Solution to Problem

A method for recovering metals disclosed herein is a method for recovering metals from battery powder of lithium ion battery waste, the method comprising: an acid leaching step of leaching metals including lithium, sodium and a metal to be separated in the battery powder into an acidic leaching solution to obtain a metal-containing solution containing the metals; and a metal separation step of separating the metal to be separated, from the metal-containing solution, wherein the lithium in the lithium-containing solution obtained after the metal separation step is returned to the acid leaching step and/or the metal separation step to circulate the lithium within a series of steps including the acid leaching step and the metal separation step, and wherein the method further comprises, after the metal separation step, a liquid removing step of removing part of the lithium-containing solution containing sodium.

### Advantageous Effects of Invention

According to the above method for recovering metals, it is possible to effectively suppress an increase in sodium concentration when lithium is circulated in a liquid in a series of steps.

### BRIEF DESCRIPTION OF DRAWINGS

FIG. 1 is a flowchart illustrating an example of a process to which a method for recovering metals according to an embodiment can be applied.

FIG. 2 is a flowchart illustrating an example of a case where the lithium-containing solution of the process of FIG. 1 is subjected to a liquid removing step according to a method for removing metals according to an embodiment.

FIG. 3 is a flowchart illustrating an example of each step for obtaining battery powder from lithium ion battery waste.

### DESCRIPTION OF EMBODIMENTS

Hereinafter, embodiments of the above method for recovering metals will be described in detail.

The method for recovering metals according to an embodiment is a method for re-covering metals from battery powder of lithium ion battery waste. The method includes: an acid leaching step of leaching metals including lithium and a metal to be separated in the battery powder into an acidic leaching solution to obtain a metal-containing solution containing those metals as metal ions; and a metal separation step of separating the metal to be separated, from the metal-containing solution.

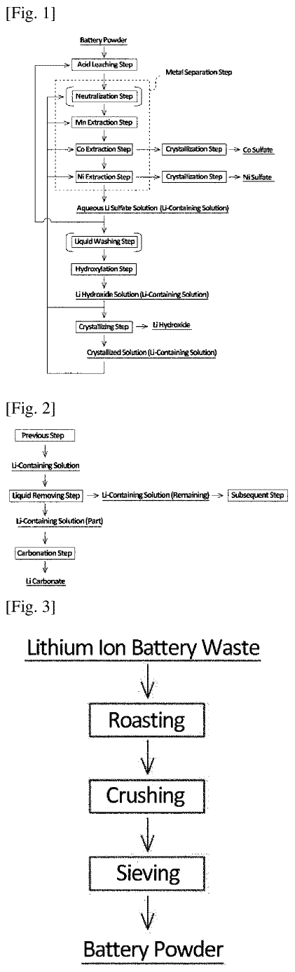

Here, as illustrated in FIG. 1, lithium in the lithium-containing solution obtained after the metal separation step is returned to the acid leaching step and/or the metal separation step in the form of a lithium sulfate solution, lithium hydroxide solution, or the like to circulate the lithium within a series of steps including the acid leaching step and the metal separation step. The above lithium hydroxide solution can be used as a pH adjusting agent or the like in the metal separation step. By circulating the lithium, a concentration of lithium in the liquid can be maintained at a higher level in a series of steps, and all the pH adjusting agents required for the metal separation step may be provided by the lithium hydroxide solution described above. Lithium hydroxide may be recovered from the remaining lithium hydroxide solution.

By the way, the battery powder may contain sodium. The sodium is leached out in the acid leaching step and contained in the metal-containing solution, and is not separated in the metal separation step together with lithium and contained in the subsequent lithium-containing solution. In this case, as described above, if the lithium in the lithium-containing solution is returned to the acid leaching step or the metal separation step to repeat the step of circulating lithium, not only the lithium con-centration but also the sodium concentration in the liquid will also increase in a series of steps. The sodium contained in the liquid at a higher concentration is contaminated, for example, in lithium hydroxide obtained in a crystallizing step to decrease its quality.

To address this, in this embodiment, after the metal separation step, a liquid removing step is performed to remove part of the lithium-containing solution containing sodium, as shown in FIG. 2. After part of the lithium-containing solution is removed in the liquid removing step, the remaining lithium-containing solution is returned to a series of steps and used for circulating lithium. By performing the liquid removing step, a part of the sodium in the lithium-containing solution after the metal separation step is removed, so that an increase in the sodium concentration can be suppressed. As a result, any deterioration of the quality of lithium hydroxide produced in the crystallizing step can be effectively suppressed.

In the embodiment shown in FIG. 1, after the metal separation step, a liquid cleaning step, a hydroxylation step, and a crystallizing step are performed in this order, and these steps are also included in the series of steps. Further, in FIG. 1, the metal separation step is specifically comprised of a neutralization step, a manganese extraction step, a cobalt extraction step, and a nickel extraction step, but at least one of these steps can be omitted, as well as other step(s) may be added. Also, the battery powder may be obtained by subjecting lithium ion battery waste to preprocessing steps such as roasting, crushing, and sieving, as illustrated in FIG. 3. Although the descriptions will be given herein according to FIGS. 1 to 3, FIGS. 1 to 3 are merely illustrative, and are not limited to such specific flows.

### Lithium Ion Battery Waste

The lithium ion battery waste of interest is lithium ion batteries which can be used in various electronic devices such as mobile phones and which have been discarded due to the expired life of the product, manufacturing defects or other reasons. The recovery of valuable metals from such lithium ion battery waste is preferred in terms of effective utilization of resources. The lithium ion battery waste refers to lithium ion batteries to be recycled, regardless of whether the lithium ion batteries are traded for a fee, at no charge, or as industrial waste.

The lithium ion battery waste has a housing containing aluminum as an exterior that wraps around the lithium ion battery. Examples of the housing include those made only of aluminum and those containing aluminum, iron, aluminum laminate, and the like. The lithium ion battery waste may also contain, in the above housing, cathode active materials composed of one single metal oxide containing lithium and one selected from the group consisting of nickel, cobalt and manganese, or a composite metal oxides containing lithium and two or more of those metals, or the like, and aluminum foils (cathode substrates) to which the cathode active materials are applied and fixed by, for example, polyvinylidene fluoride (PVDF) or other organic binders. In addition, the lithium ion battery waste may also contain copper, iron, or the like. Further, the housing of the lithium ion battery waste typically contains an electrolytic solution having an electrolyte such as lithium hexafluorophosphate dissolved in an organic solvent. As the organic solvent, ethylene carbonate, diethyl carbonate or the like may be used, for example.

### Preprocessing Step

In many cases, the lithium ion battery waste is subjected to preprocessing step as a dry process. The preprocessing step may include at least one of roasting, crushing and sieving. The lithium ion battery waste becomes battery powder through the pre-processing step. The roasting, crushing, and sieving in the preprocessing step may optionally be performed, respectively, or they may be performed in any order. The battery powder means the powder obtained by subjecting the lithium ion battery waste to any preprocessing to separate and concentrate cathode material components. The battery powder may be obtained as a powder by crushing and sieving the lithium ion battery waste with or without a heat treatment to concentrate the cathode material components.

In the roasting, the above lithium ion battery waste is heated. When the roasting is carried out, metals such as lithium and cobalt contained in the lithium ion battery waste is changed to an easily dissolvable form. During the roasting, the lithium ion battery waste is preferably heated by maintaining it in a temperature range of, for example, from 450° C. to 1000° C., preferably in a temperature range of from 600° C. to 800° C., for 0.5 to 4 hours. In the roasting, one of the heating in an air atmosphere or the heating in an inert atmosphere such as nitrogen can be carried out, as well as both the heating in the air atmosphere and the heating in the inert atmosphere may be carried out in this order or opposite order. The roasting can be of butch type or continuous type. For example, the batch type includes a stationary furnace, the continuous type includes a rotary kiln furnace, and other various types of furnaces can also be used.

During the roasting, at least a part of the electrolytic solution is removed from the lithium ion battery waste because the electrolytic solution is evaporated, or the like. In many cases, when the lithium ion battery waste is heated during the roasting, the components of the internal electrolytic solution are sequentially evaporated, starting with the component having a lower boiling point. When the roasting is carried out, the electrolytic solution is removed and rendered harmless, and the organic binder is de-composed to promote separation between the aluminum foil and the cathode active material during crushing and sieving, which will be described below. Although the composition of the cathode active material changes due to roasting, the material that has undergone the roasting is also referred to as the cathode active material.

After the roasting, the crushing can be carried out to remove cathode active materials and the like from the housing of the lithium ion battery waste. The crushing selectively separates the cathode active materials from the aluminum foils to which the cathode active materials are applied, while destroying the housing of the lithium ion battery waste.

Various known apparatuses or devices can be used for the crushing. In particular, it is preferable to use an impact-type crusher that can crush lithium ion battery waste by applying an impact while cutting it. Examples of the impact-type crusher include a sample mill, a hammer mill, a pin mill, a wing mill, a tornado mill, and a hammer crusher. It should be noted that a screen can be installed at an exit of the crusher, whereby the lithium ion battery waste is discharged from the crusher through the screen when it is crushed to a size that can pass through the screen.

After crushing the lithium ion battery waste, the sieving is performed by sieving it using a sieve having an appropriate sieve opening. Thus, aluminum or copper remains on the sieve, and the battery powder that has removed aluminum or copper to some extent can be obtained under the sieve.

The battery powder obtained in the preprocessing step contains nickel, cobalt, lithium, manganese, and the like. For example, a content of nickel in the battery powder is 1% to 30% by mass, a content of cobalt is 1% to 30% by mass, a content of lithium is 2% to 8% by mass, a content of manganese is 1% to 30% by mass, although not limited thereto. The battery powder may further contain 1% to 10% by mass of aluminum, 1% to 5% by mass of iron, 1% to 10% by mass of copper, and 0.001% by mass to 0.1% by mass of sodium. In this embodiment, the battery powder containing lithium, sodium, and a metal to be separated is targeted. The metal to be separated may include at least one selected from the group consisting of nickel, cobalt, manganese, aluminum, iron, and copper.

### Acid Leaching Step

In the acid leaching step, the metals in the battery powder are leached with an acidic leaching solution such as sulfuric acid. As a result, the metals in the battery powder are dissolved to obtain a solution that has dissolved the metals in the battery powder, and a leached residue that has remained undissolved. As used herein, the solution in which the metals in the battery powder are dissolved in each step from the end of leaching in the acid leaching step to the nickel extraction step as described below is also referred to as a metal-containing solution.

In the acid leaching step, the pH of the acidic leaching solution or leached solution may be, for example, less than 3.5. Moreover, an oxidation-reduction potential (ORP value, based on silver/silver chloride potential) may be 100 mV or less. After leaching, solid-liquid separation may be performed to separate the leached residue from the metal-containing solution, but the solid-liquid separation may not be performed and the metal-containing solution containing the leached residue may be subjected to the next neutralization step. As a diluent for adjusting the pH of the acidic leaching solution, an extracted solution (a lithium sulfate solution or the like) in a nickel extraction step as described below or water can be used. Thus, the lithium is circulated in a series of steps in the wet process, and the lithium in the solution can be concentrated in the steps.

The metal-containing solution obtained in the acid leaching step may have, for example, a nickel concentration of 10 g/L to 50 g/L, a cobalt concentration of 5 g/L to 50 g/L, a lithium concentration of 2g/L to 10g/L, a manganese concentration of 0 g/L to 50 g/L, an aluminum concentration of 1.0 g/L to 20 g/L, an iron concentration of 0.1 g/L to 5.0 g/L, a copper concentration of 0.005 g/L to 0.2 g/L, and a sodium con-centration of 0.001 g/L to 0.1 g/L.

### Neutralization Step

When the metal-containing solution obtained in the acid leaching step contains aluminum and/or iron, at the start of the metal separation step, the neutralization step can be carried out by increasing the pH of the metal-containing solution to separate a neutralized residue to obtain a neutralized solution. The neutralization step may include an aluminum removal stage and an iron removal stage. However, if the metal-containing solution does not contain aluminum and/or iron, the aluminum removal step and/or iron removal step may be omitted.

In the aluminum removal step, the pH of the metal-containing solution is increased to precipitate at least a part of the aluminum and remove it by solid-liquid separation. At this time, for example, when the pH is increased in the range of 4.0 to 5.0 with a pH adjusting agent at a solution temperature of 50° C. to 90° C., the aluminum can be effectively separated while suppressing precipitation of nickel and/or cobalt.

In the iron removal step, an oxidizing agent is added and a pH adjusting agent is further added to increase the pH in a range of 4.0 to 5.0. As a result, the iron is oxidized from divalent to trivalent one, and precipitated as a solid such as an oxide or iron hydroxide (Fe(OH)₃), which can be removed by solid-liquid separation. The oxidation-reduction potential (ORP value, based on silver/silver chloride potential) during oxidation is preferably 300 mV to 900 mV. The oxidizing agent is not particularly limited as long as it can oxidize iron, but it may preferably be manganese dioxide, a cathode active material, and/or a manganese-containing leached residue obtained by leaching a cathode active material. The manganese-containing leached residue obtained by leaching the cathode active material with the acid may include manganese dioxide. When the cathode active material or the like is used as the oxidizing agent, it causes a precipitation reaction which converts manganese dissolved in the liquid to manganese dioxide, so that the precipitated manganese can be removed together with iron.

Examples of the pH adjusting agent used in neutralization in the above aluminum removal stage and iron removal stage include lithium hydroxide, sodium hydroxide, sodium carbonate, and ammonia, in the form of a solid or liquid. Among them, lithium hydroxide is preferable because it is possible to prevent sodium and the like from being mixed into lithium hydroxide recovered in a hydroxylation step as described below. For the pH adjusting agent, a lithium hydroxide solution obtained in the hydroxylation step or a crystallized solution (a lithium hydroxide solution) obtained in the crystallizing step can be used, so that lithium is circulated in the series of the steps.

### Manganese Extraction Step

The metal-containing solution can be subjected to a solvent extraction method to extract and remove the manganese, after undergoing the above neutralization step if necessary. Here, when aluminum remains in the metal-containing solution, the manganese as well as the aluminum are also extracted and removed.

In the extraction of the manganese, an extracting agent containing a phosphate ester-based extracting agent is preferably used. Specific examples of the phosphate ester-based extracting agent include di-2-ethylhexyl phosphate (abbreviated name: D2EHPA, for example, trade name: DP8R). Further, the extracting agent may be a mixture of the phosphate ester-based extracting agent and an oxime-based extracting agent. In this case, the oxime-based extracting agent is preferably aldoxime or based on aldoxime. Specific examples include 2-hydroxy-5-nonylacetophenone oxime (trade name: LIX84), 5-dodecyl salicylaldoxime (trade name: LIX860), a mixture of LIX84 and LIX860 (trade name: LIX984), 5-nonyl salicylaldoxime (trade name: ACORGAM5640) and the like.

The extracting agent may be diluted with an aromatic, paraffinic, naphthenic, or other hydrocarbon organic solvent to a concentration of 10% to 30% by volume and used as a solvent.

During extraction, an equilibrium pH is preferably 2.3 to 3.5, and more preferably 2.5 to 3.0. As the pH adjusting agent used at this time, a lithium hydroxide solution is preferably used, and for example, a lithium hydroxide solution obtained in a hydroxylation step or a crystallization step as described below can be used.

As an example, the extraction is more specifically carried out by bringing a solution (aqueous phase) into contact with a solvent (organic phase), stirring and mixing them, typically with a mixer, for example, for 5 to 60 minutes, to allow the metal to react with the extracting agent. The temperature during extraction is from ordinary temperature (approximately 15 to 25° C.) to 60° C. or lower, and it is preferably carried out at 35 to 45° C. for reasons of an extraction rate, phase separation, and evaporation of the organic solvent. The mixed organic phase and aqueous phase are then separated in a settler based on a difference in specific gravity. Extraction in steps other than the manganese extraction step can also be carried out in substantially the same manner.

At the time of extraction, it is desirable to carry out extraction by countercurrent type multistage extraction in which directions of flow of the aqueous phase and the solvent used for each extraction are opposite to each other. By doing so, the extraction rate of manganese can be increased while suppressing the extraction of cobalt, nickel, and lithium. In the case of the countercurrent type multistage extraction, it is effective to set the equilibrium pH at the first stage of extraction to a value in the above range, and lower the equilibrium pH at the time of extraction through successive stages.

In the metal-containing solution after the manganese extraction step, for example, the cobalt concentration may be 0 g/L to 50 g/L, and the nickel concentration may be 0 g/L to 50 g/L, and the lithium concentration may be 1 g/L to 30 g/L, and the sodium concentration may be 0.001 g/L to 0.1 g/L.

### Cobalt Extraction Step and Crystallization Step

After manganese is extracted, cobalt can be extracted and separated from the metal-containing solution by a solvent extraction method.

It is preferable to use a solvent containing a phosphoric acid-based extracting agent, especially a phosphonate ester-based extracting agent, for the extraction of the cobalt. Particularly, 2-ethylhexyl 2-ethylhexylphosphonate (trade name: PC-88A, Ionquest 801) is preferable from the viewpoint of separation efficiency between nickel and cobalt. The extracting agent may be diluted with a hydrocarbon-based organic solvent so as to have a concentration of 10% by volume to 30% by volume and used as a solvent.

When extracting the cobalt, the equilibrium pH during extraction is preferably 5.0 to 6.0, and more preferably 5.0 to 5.5. If the pH is less than 5.0, cobalt may not be sufficiently extracted into the solvent. As the pH adjusting agent at this time, a lithium hydroxide solution is preferably used, for example, a lithium hydroxide solution obtained in a hydroxylation step or a crystallization step as described below can be used.

In the extraction of the cobalt as well, it is desirable to carry out the extraction by countercurrent type multistage extraction in which flow directions of the aqueous phase and the solvent used for each extraction are opposite to each other. By doing so, it is possible to increase an extraction rate of cobalt while suppressing the extraction of nickel and lithium.

During the above extraction, not only cobalt but also nickel and/or lithium may be somewhat extracted into the solvent. In this case, if necessary, the solvent that has extracted the cobalt may be subjected to one or more scrubbing processes using a scrubbing solution to remove nickel and/or lithium that may be contained in the solvent. The scrubbing solution can be, for example, a sulfuric acid solution having a pH of 3.5 to 5.5. The scrubbed solution may contain nickel and/or lithium. Therefore, part or all of the scrubbed solution is mixed with the metal-containing solution after the manganese extraction step and it is used as an extracting solution to carry out the cobalt extraction step. As a result, the nickel and/or lithium can be circulated or retained in the series of steps without losing them. However, if the solvent used to extract the cobalt does not contain nickel and/or lithium, the scrubbing may not be performed.

The solvent containing the cobalt is then subjected to stripping. A stripping solution used for the stripping may be any inorganic acid such as sulfuric acid, hydrochloric acid, and nitric acid, but sulfuric acid is preferable when a sulfate is obtained in the next crystallization step. Here, it is carried out under pH conditions such that the cobalt completely transfers from the solvent to the stripping solution as much as possible. Specifically, the pH is preferably in the range of 2.0 to 4.0, and more preferably in the range of 2.5 to 3.5.

The stripped solution can be subjected to a crystallization step. In the crystallization step, the stripped solution is heated to, for example, 40° C. to 120° C. and concentrated. As a result, the cobalt is crystallized to obtain a cobalt salt such as cobalt sulfate. The cobalt salt thus obtained preferably has a nickel content of 5 ppm by mass or less, and have sufficiently removed the nickel, so that it can be effectively used as a raw material for producing lithium ion batteries or other batteries. Here, the crystallized solution may contain uncrystallized cobalt and lithium. Therefore, it is preferable that the crystallized solution is mixed with the stripped solution before the crystallization step and used for recrystallization step, or used for adjusting the cobalt concentration of the scrubbing solution used for the solvent that has extracted the cobalt, or mixed with the metal-containing solution after the manganese extracting agent and used for the cobalt extraction step. By doing so, the cobalt and lithium can be circulated or retained and concentrated in the series of steps without losing them.

### Nickel Extraction Step and Crystallization Step

The metal-containing solution after extracting the cobalt in the cobalt extraction step mainly contains nickel and lithium. In order to recover the nickel from the metal-containing solution, the nickel can be extracted from the metal-containing solution into a solvent by a solvent extraction method.

The extraction may employ a mixer-settler. In this case, first, the pH is adjusted by, for example, including a pH adjusting agent in the solvent, and then mixing the metal-containing solution (aqueous phase) with the solvent (organic phase) in a mixer to form a mixed solution, which is stirred. At this time, the nickel in the metal-containing solution migrate to the solvent. The mixed solution is then left to stand in a settler, and the aqueous phase and organic phase are separated based on a difference between their specific gravities. This provides an extracted solution that has separated the solvent.

The solvent used in the nickel extraction step preferably contains a carboxylic acid-based extracting agent. Examples of the carboxylic acid-based extracting agent include neodecanoic acid and naphthenic acid. Among them, the neodecanoic acid (Versatic Acid 10 (VA-10) manufactured by Shell Chemicals) is preferred because of its ability to extract nickel. The extracting agent may be diluted with an aromatic, paraffinic, naphthenic, or other hydrocarbon-based organic solvent to a concentration of 10% to 30% by volume and used as a solvent.

The equilibrium pH during the extraction is preferably 6.0 to 8.0, and more preferably 6.8 to 7.2. The pH adjusting agent used to adjust the pH at this time is preferably a lithium hydroxide solution, for example, a lithium hydroxide solution obtained in a hydroxylation step and a crystallizing step as described below can be used.

The extraction is preferably carried out in multiple stages using a countercurrent method in which the metal-containing solution and the solvent flow in opposite directions. By doing so, the extraction of lithium into the solvent can be suppressed, and the extraction rate of nickel can be increased. When performing multi-stage countercurrent extraction, it is effective, for example, to set the equilibrium pH during the first stage of extraction to a value within the above range, and then lower the equilibrium pH through successive stages of extraction.

The solvent that has contained the nickel by the extraction may optionally be subjected to one or more scrubbing processes using a scrubbing solution to remove lithium that may be contained in the solvent. The scrubbing solution can be, for example, a sulfuric acid solution having a pH of 5.0 to 6.0. Here, the resulting scrubbed solution may contain lithium. Therefore, it is preferable that a part or all of the scrubbed solution is mixed with the metal-containing solution after the cobalt extraction step, and it is used as the extracting solution to carry out the nickel extraction step. As a result, the lithium can be circulated or retained and concentrated in the series of steps without losing it. However, if the solvent containing the nickel does not contain lithium, the scrubbing may not be performed.

The solvent containing the nickel is then subjected to stripping using a stripping solution. The stripping solution may be any inorganic acid such as sulfuric acid, hydrochloric acid, and nitric acid, but if a sulfate salt is obtained in the next crystallization step, sulfuric acid is preferred. The pH is preferably in the range of 1.0 to 3.0, and more preferably 1.5 to 2.5. Although the O/A ratio and the number of times can be determined as needed, the O/A ratio is 5 to 1, and more preferably 4 to 2.

When the extracted solution such as a nickel sulfate solution is obtained by the stripping, electrolysis and dissolution can be carried out as needed, and the solution can be then heated to 40° C. to 120° C. in the crystallization step to crystalize the nickel as a nickel salt such as nickel sulfate. This provides the nickel salt. Here, the crystallized solution may contain uncrystallized nickel and lithium. Therefore, the crystallized solution is mixed with the stripped solution before the crystallization step and used for a recrystallization step, or used for adjusting the nickel concentration of the scrubbing solution with respect to the solvent containing the nickel, or mixed with the metal-containing solution after the cobalt extraction step and used for the nickel extraction step. By doing so, the nickel and lithium can be circulated or retained and concentrated in the series of steps without losing them.

The extracted solution (a lithium sulfate solution or the like) in which the nickel has transferred to the solvent mainly contains lithium and may be added to the acidic leaching solution in the acid leaching step. This allows the lithium contained in the extracted solution to be circulated in the series of steps. Preferably, after the lithium concentration in the extracted solution has been increased to some extent by thus circulating the lithium, a hydroxylation step as described below can be carried out.

### Liquid Cleaning Step

The lithium-containing solution (lithium sulfate solution) which is the extracted solution in the nickel extraction step as described above may contain trace amounts of cations such as nickel and magnesium that could not be completely separated in the metal separation step. The nickel and magnesium are cations like lithium, and exhibit the same behavior as lithium during electrodialysis or the like in a hydroxylation step as described below, so that it is difficult to separate them from lithium. Also, when the electrodialysis is performed on the metal-containing solution containing the nickel and magnesium, hydroxides of nickel and magnesium may be generated in the resulting lithium hydroxide solution, and the electrodialysis cannot be continued due to troubles of the steps.

Therefore, in such a case, it is desirable to carry out liquid cleaning of the metal-containing solution to remove cations such as nickel and magnesium prior to the hydroxylation step. The liquid cleaning can be carried out using an ion exchange resin or a chelate resin, for example. However, if the lithium-containing solution obtained in the nickel extraction step does not contain nickel, magnesium, and the like, the liquid cleaning step may be omitted.

### Hydroxylation Step

In the hydroxylation step, a hydroxylation process is subjected to the lithium-containing solution such as the lithium sulfate solution to prepare a lithium hydroxide solution. The details of the hydroxylation process are not particularly limited as long as the lithium hydroxide solution can be prepared, but, for example, it includes a carbonation and chemical conversion method that uses calcium hydroxide after preparing lithium carbonate, a chemical conversion method that uses barium hydroxide, an electrodialysis method, and the like.

For the carbonation and chemical conversion method, first, a lithium carbonate solution is obtained by adding a carbonate to or blowing a carbon dioxide gas into a lithium-containing solution. Subsequently, in a so-called chemical conversion method, calcium hydroxide can be added to the lithium carbonate solution to generate the lithium hydroxide solution under the reaction formula: Li₂CO₃+Ca(OH)₂→2LiOH+CaCO₃. Calcium that may remain in the solution can be removed with a cation exchange resin, a chelate resin, or the like.

When barium hydroxide is used, barium hydroxide can be added to the lithium-containing solution to obtain the lithium hydroxide solution based on the reaction: Li₂SO₄+Ba(OH)₂→2LiOH+BaSO₄. At this time, barium that can be dissolved in the solution can be separated and removed using a cation exchange resin, a chelate resin, or the like.

For the electrodialysis, in a bipolar membrane electrodialysis device, the lithium-containing solution is introduced into a desalting chamber between an anion exchange membrane and a cation exchange membrane, and pure water is introduced into each of an acid chamber between a bipolar membrane and an anion exchange membrane and an alkaline chamber between a cation exchange membrane and a bipolar membrane, and a voltage is applied between the electrodes. Then, the lithium ions in the metal-containing solution in the desalting chamber move to the alkaline chamber where the bipolar membrane decomposes the pure water into hydroxide ions to obtain a lithium hydroxide solution. It should be noted that anions of an inorganic acid such as sulfates in the metal-containing solution in the desalting chamber pass through the anion exchange membrane and move to the acid chamber.

At least a part of the lithium hydroxide solution obtained as described above is effectively used as an alkaline pH adjusting agent used in the metal separation step (in the embodiment shown in FIG. 1, at least one step selected from the group consisting of the neutralization step, the manganese extraction step, the cobalt extraction step, and the nickel extraction step).

### Crystallizing Step

The lithium hydroxide solution obtained in the hydroxylation step can be subjected to a crystallizing step. For example, when the lithium hydroxide solution is returned to the metal separation step as a pH adjusting agent as described above, the lithium in the newly added battery powder may gradually increase the lithium concentration in the liquid. Depending on the lithium concentration, the crystallizing step may be performed to recover lithium as lithium hydroxide.

In the crystallizing step, a crystallizing operation such as heat concentration or vacuum distillation can be performed in order to precipitate lithium hydroxide. For the heat concentration, a higher temperature during crystallizing leads to faster progression of the process, which is preferable. However, the temperature of the crystallized product after crystallizing is preferably less than 60° C. at which water of crystallization is not released. This is because anhydrous lithium hydroxide that has released the water of crystallization is deliquescent and thus difficult to be handled. Subsequently, a pulverization process or the like can be performed in order to adjust the lithium hydroxide to required physical properties.

Further, in the crystallizing step, a crystallized solution is obtained as a lithium hydroxide solution in which lithium hydroxide remains without being precipitated. In the metal separation step, it is possible to adjust the lithium hydroxide solution after the hydroxylation step or the solid lithium hydroxide as described above to use it as a pH adjusting agent, but as shown in FIG. 1, the crystallized solution is used as a pH adjusting gent. This is because the crystallized solution has a concentration close to the saturated solubility of lithium hydroxide (about 120 g/L), and if this is used as a pH adjusting agent, no adjustment will be required when using the solid lithium hydroxide, and an amount of an alkali can be further reduced.

### Liquid Removing Step

When lithium is circulated through the series of steps and the sodium concentration in the liquid increases to a certain extent, sodium will be mixed into the lithium hydroxide obtained in the above crystallizing step, thereby decreasing the quality of the lithium hydroxide.

To address this, in this embodiment, after the metal separation step, a liquid removing step is performed by removing a part of the lithium-containing solution containing sodium obtained in the previous step, as shown in FIG. 2. The remaining lithium-containing solution that remains after removing a part of the lithium-containing solution in the liquid removing step is subjected to a subsequent step. This allows for removal of part of the sodium in the lithium-containing solution after the metal separation step, thereby suppressing an increase in the sodium concentration caused by battery powder containing sodium, which is newly introduced into the wet process.

Thus, in the crystallizing step, lithium hydroxide having a low sodium content can be obtained by adjusting the concentration ratio in view of the difference in solubility between lithium and sodium. More details are as follows. In the crystallizing step, the liquid at the time of crystallizing becomes a saturated lithium hydroxide solution, and an amount of lithium hydroxide that cannot be dissolved is precipitated as a solid. In this case, lithium becomes saturated in the above liquid, but sodium is often not saturated. Therefore, as the weight of sodium carried into the crystallizing step due to sodium in the battery powder increases, the Li/Na concentration ratio of the above liquid decreases. Here, for example, if the liquid removing step is performed once when the Li/Na concentration ratio becomes smaller, the weight of sodium carried into the crystallizing step decreases. In the crystallizing step, crystallizing is performed until a constant liquid volume is reached, and as the weight of sodium carried into the crystallizing step decreases, the sodium concentration in the liquid at the time of crystallization decreases, and the Li/Na concentration ratio increases. If the crystallized solution having such a higher Li/Na concentration ratio is circulated as a pH adjusting agent in a series of steps, the weight of sodium in the circulating solution will decrease, so that the sodium concentration of the lithium-containing solution after the metal separation step can be reduced. When the liquid removing step is incorporated into the series of steps to perform it constantly, the weight of sodium in the circulating liquid continues to decrease, making it possible to maintain a low sodium concentration in the lithium-containing solution after the metal separation step. As a result, in the crystallizing step, lithium hydroxide having a lower sodium content can be obtained.

The liquid removing step may be periodically or irregularly carried out when the sodium concentration of the lithium-containing solution increases to a certain degree while continuously operating the series of steps as illustrated in FIG. 1. However, it can also be incorporated into the series of step to perform it constantly. In any case, it is preferable to perform the liquid removing step so that the sodium concentration of the lithium-containing solution (more specifically, the lithium hydroxide solution or the like used in the crystallizing step) is maintained at 500 mg/L or less. More preferably, the liquid removing step can be performed so that the sodium concentration of the lithium-containing solution is maintained at 300 mg/L or less, or even 100 mg/L or less. At this time, the lithium concentration of the lithium-containing solution to be subjected to the liquid removing step may be 5.0 g/L to 35.0 g/L. The sodium con-centration can be measured in at least one of the acid leaching step, the neutralization step, the manganese extraction step, the cobalt extraction step, the nickel extraction step, the cleaning step, and the hydroxylation step, and preferably in each of these steps. This allows the sodium concentration of the lithium-containing solution to be controlled. Further, an ICP-OES (ICP emission spectrometer) is used to measure the concentration.

Regarding the pre-step and the post-step in FIG. 2, the liquid removing step can be performed at any stage after the metal separation step where the concentration of the metal to be separated becomes sufficiently low. For example, as shown in FIG. 1, when the liquid cleaning step, the hydroxylation step, and the crystallizing step are carried out after the metal separation step (nickel extraction step), the liquid removing step can be carried out for the lithium-containing solution (lithium sulfate solution or the like) between the metal separation step and the liquid cleaning step, the lithium-containing solution (lithium sulfate solution or the like) between the liquid cleaning step and hydroxylation step, the lithium-containing solution (lithium hydroxide solution or the like) between the hydroxylation step and the crystallizing step, and/or the lithium-containing solution (lithium hydroxide solution) after the crystallizing step. In addition, if the liquid cleaning step is omitted, the liquid removing step may be carried out between the metal separation step and the hydroxylation step.

In many cases, it is preferable to carried out the liquid removing step at an early stage from the viewpoint of cost reduction, because the lithium-containing solution having a lower sodium concentration will be handled in the subsequent step. However, if the liquid removing step is carried out between the metal separation step and the liquid cleaning step, a part of the lithium-containing solution removed in the liquid removing step may contain nickel, magnesium, and the like, because the liquid cleaning step is not performed. In this case, as described below, in order to obtain high-grade lithium carbonate in a carbonation step for a part of the lithium-containing solution, it is preferable that neutralization is carried out to remove nickel, magnesium, and the like, before the carbonation. Preferably, the liquid removing step is carried out before the hydroxylation step and after removing nickel, magnesium, and the like in the liquid cleaning step.

It should be noted that, in order to actually perform the liquid removing step, a part of the lithium-containing solution can be removed from containers such as storage tanks used in the steps as described above, or from piping or flow paths used for liquid transfer between certain steps. More specifically, for example, a branch path may be provided in the piping connecting the steps to adjust a flow rate of the lithium-containing solution sent onto the branch pass side and removed, by means of a valve or a diameter of the pipe. However, the lithium-containing solution can be removed by various specific methods without limiting the above means, and such means can be selected as needed.

### Carbonation Step

A part of the lithium-containing solution removed in the liquid removing step contains lithium. In order to recover the lithium as lithium carbonate, the part of the lithium-containing solution can be subjected to a carbonation step.

In the carbonation step, lithium carbonate can be precipitated by, for example, adding a carbonate salt such as sodium carbonate to the part of the lithium-containing solution or carbonating it by blowing a carbon dioxide gas into the solution. From the viewpoint of preventing an increase in impurities, the blowing of the carbon dioxide gas is preferable. After adding the carbonate salt or blowing the carbon dioxide gas, for example, the liquid temperature can be maintained in the range of 50° C. to 90° C., and stirred as necessary, and this temperature can be maintained for 0.5 to 2 hours.

If part of the lithium-containing solution contains impurities such as nickel and magnesium due to the liquid removing step being carried out between the metal separation step and the liquid cleaning step, it is preferable that neutralization may be carried out before the carbonation to remove the impurities. In the neutralization, nickel, magnesium, and the like are precipitated by adding an alkali, and these are separated and removed by solid-liquid separation. At this time, any alkali can be used, and the lithium hydroxide solution obtained in the hydroxylation step or the crystallizing step may also be used.

The lithium carbonate obtained as described above may be subjected to purification such as cleaning, dissolving, and decarboxylation, as needed, in order to increase its purity.

1. A method for recovering metals from battery powder of lithium ion battery waste, the method comprising:
an acid leaching step of leaching metals including lithium, sodium and a metal to be separated in the battery powder into an acidic leaching solution to obtain a metal-containing solution containing the metals; and a metal separation step of separating the metal to be separated, from the metal-containing solution,
wherein the lithium in the lithium-containing solution obtained after the metal separation step is returned to the acid leaching step and/or the metal separation step to circulate the lithium within a series of steps including the acid leaching step and the metal separation step, and
wherein the method further comprises, after the metal separation step, a liquid removing step of removing part of the lithium-containing solution containing sodium.

2. The method for recovering metals according to claim 1, wherein the method comprises, after the metal separation step, a hydroxylation step of subjecting the lithium-containing solution to a hydroxylation process to obtain a lithium-containing solution as a lithium hydroxide solution.

3. The method for recovering metals according to claim 2, wherein the liquid removing step is carried out on the lithium-containing solution between the metal separation step and the hydroxylation step.

4. The method for recovering metals according to claim 2,
wherein the method comprises a liquid cleaning step of removing impurities in the lithium-containing solution between the metal separation step and the hydroxylation step, and
wherein the liquid removing step is carried out on the lithium-containing solution between the metal separation step and the liquid cleaning step and/or between the liquid cleaning step and the hydroxylation step.

5. The method for recovering metals according to claim 2, wherein the method comprises a crystallizing step of obtaining lithium hydroxide from the lithium-containing solution as the lithium hydroxide solution.

6. The method for recovering metals according to claim 5, wherein the liquid removing step is carried out on the lithium-containing solution as the lithium hydroxide solution, between the hydroxylation step and the crystallizing step.

7. The method for recovering metals according to claim 5, wherein, after the crystallizing step, the liquid removing step is carried out on the lithium-containing solution as a crystallized solution obtained in the crystallizing step.

8. The method for recovering metals according to claim 1,
wherein the series of steps are continuously carried out, and
wherein the liquid removing step is carried out so that a sodium concentration of the lithium-containing solution is maintained at 500 mg/L or less.

9. The method for recovering metals according to claim 1, wherein the method comprises a carbonation step of recovering lithium in the part of the lithium-containing solution removed in the liquid removing step as lithium carbonate.

10. The method for recovering metals according to claim 9, wherein, in the carbonation step, the lithium carbonate is precipitated by adding a carbonate salt or feeding a carbon dioxide gas after neutralizing the part of the lithium-containing solution and removing impurities.
